(19) United States
(12) Patent Application Publication
(10) Pub. No.: US 2010/0127642 A1
(43) Pub. Date: May 27, 2010

(54) Cluster control device of street lamp circuits

(76) Inventor: Shou-Shan Chen, Junghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/588,874

(22) Filed: Oct. 30, 2009

(30) Foreign Application Priority Data
Nov. 21, 2008 (TW) 97220750

(51) Int. Cl. H05B 37/00

(52) U.S. Cl. 315/312

(57) ABSTRACT

A cluster control device, which is provided for controlling street lamps, includes a plurality of control modules and at least one master controller. The control modules are respectively connected to the street lamps that are included in a power supply circuit. Each control module functions to control the respective street lamp in accordance with control parameters stored in a memory. The master controller is set in communication with each of the control modules to read and write control parameters stored in the memory of each control module for controlling all the street lamps in a clustered manner.

### FIELD OF THE INVENTION

The present invention relates to a control device for street lamps, and in particular to a cluster control device of street lamps.

### BACKGROUND OF THE INVENTION

Conventionally, street lamps are grouped in different clusters for sectionized supply of electrical power. To meet the demand of saving energy and reducing power consumption, supply of electrical power to the street lamps in a street in time periods when less pedestrians, passer-bys, or vehicles moving through the street may adopt such a mode that the street lamps are lit every alternate ones. Lamp bulbs used in street lamps are of several types, including sodium vapor lamps, electrodeless lamps, semiconductor lamps, and light-emitting diode (LED) lamps, among which the LED lamps are most potential in replacing other types of street lamps.

### SUMMARY OF THE INVENTION

However, sectionized power supply may lead to apparent dark zones in the lighting brightness of the street lamps, and in addition, timer controllers must be incorporated in the lamp circuit of a controlled lamp. This may cause undesired trouble in resuming the greatest brightness during a power consumption reduced period. Further, the centralized control for the wiring arrangement of this mode may require increased costs in constructing wiring ducts.

In addition, certain problems must be overcome before the LED street lamp can become prevailing. For example, in long-time illumination operation, the LED lamps not only consumes a great amount of electrical power, but also generates a great amount of heat, which often leads to damage and malfunctioning of the LED street lamps and also reduces the lighting efficiency of the street lamps, and may even cause total failure of the whole street lamp system due to the undesired excessively high temperature.

Thus, an objective of the present invention is to provide a cluster control device of street lamp circuits, which uses an existing power supply circuit of street lamps to perform both functions of communication and supply of electrical power, so that street lamps can be operated in various modes for being lit individually or in combination with other street lamps.

Another objective of the present invention is to provide a cluster control device of street lamp circuits, which performs control of all the street lamps of the street lamp circuits in a clustered manner for individually adjusting lighting mode of each street lamp so as to realize individual adjustment and setting for different types of street lamp.

The technical solution that the present invention adopts to overcome the above discussed problems comprises a plurality of control modules and at least one master controller. The control modules are respectively connected to a plurality of street lamps included in a power supply circuit. Each control module functions to control the respective street lamp in accordance with control parameters stored in a memory. The master controller is set in communication with each of the control modules to read and write control parameters stored in the memory of each control module.

With the technical solution adopted in the present invention, a power supply circuit for street lamps is expanded in the functions thereof so that the power supply circuit may also provide communication between a master controller and control modules for transmission of synchronous calibration signal, brightness control ratio, and control parameters so as to realize a communication mechanism for reading/writing and transmission of data.

Further, each street lamp is controlled by a dedicated control module, which may perform a control operation that provides the street lamp with different brightness at different periods of time in accordance with control parameters stored in a memory and may also allow the illuminance of all the street lamps to be increased/decreased at the same time, or making the brightness of a specific street lamp controlled in a manner different from other street lamps. For example, an LED street lamp can be controlled in respect of time period of lighting and ratio of brightness in accordance with heat generation of the LED lamp so as to extend the service life of the LED lamp.

### BRIEF DESCRIPTION OF THE DRAWINGS

The present invention will be apparent to those skilled in the art by reading the following description of preferred embodiments thereof with reference to the drawings, in which:

FIG. 1 shows a system block diagram of a first embodiment in accordance with the present invention;

FIG. 2 shows a circuit diagram of a master controller;

FIG. 3 shows a circuit diagram of a control module; and

FIG. 4 shows a system block diagram of a second embodiment in accordance with the present invention.

### DETAILED DESCRIPTION OF THE PREFERRED EMBODIMENTS

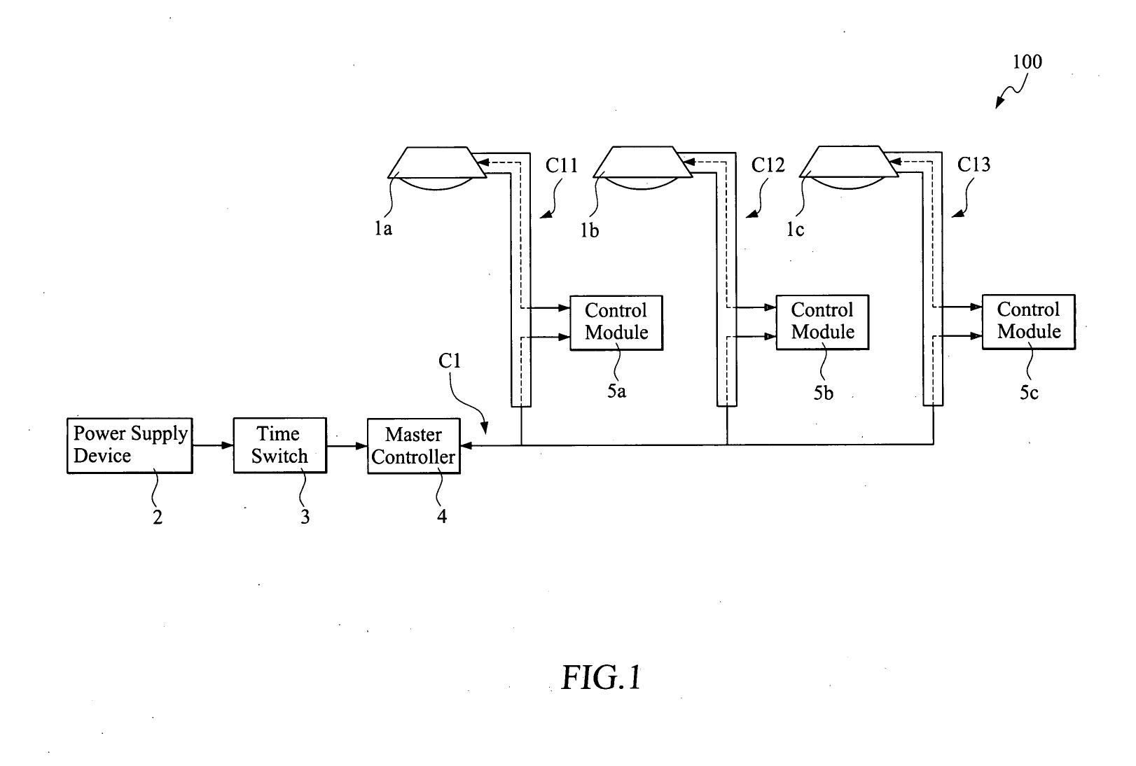

With reference to the drawings and in particular to FIG. 1, a cluster control device 100 is provided in accordance with the present invention for street lamp circuits. The cluster control device 100 comprises a power supply circuit C1 that is connected to a plurality of street lamp circuits C11, C12, C13. Each of the street lamp circuits C11, C12, C13 comprises a street lamp 1a, 1b, 1c and the power supply circuit C1 transmits electrical power supplied from a power supply device 2 through a time switch 3 to each of the street lamps 1a, 1b, 1c.

Each street lamp 1a, 1b, 1c is connected to a control module 5a, 5b, 5c, which is selectively set in communication with a master controller 4.

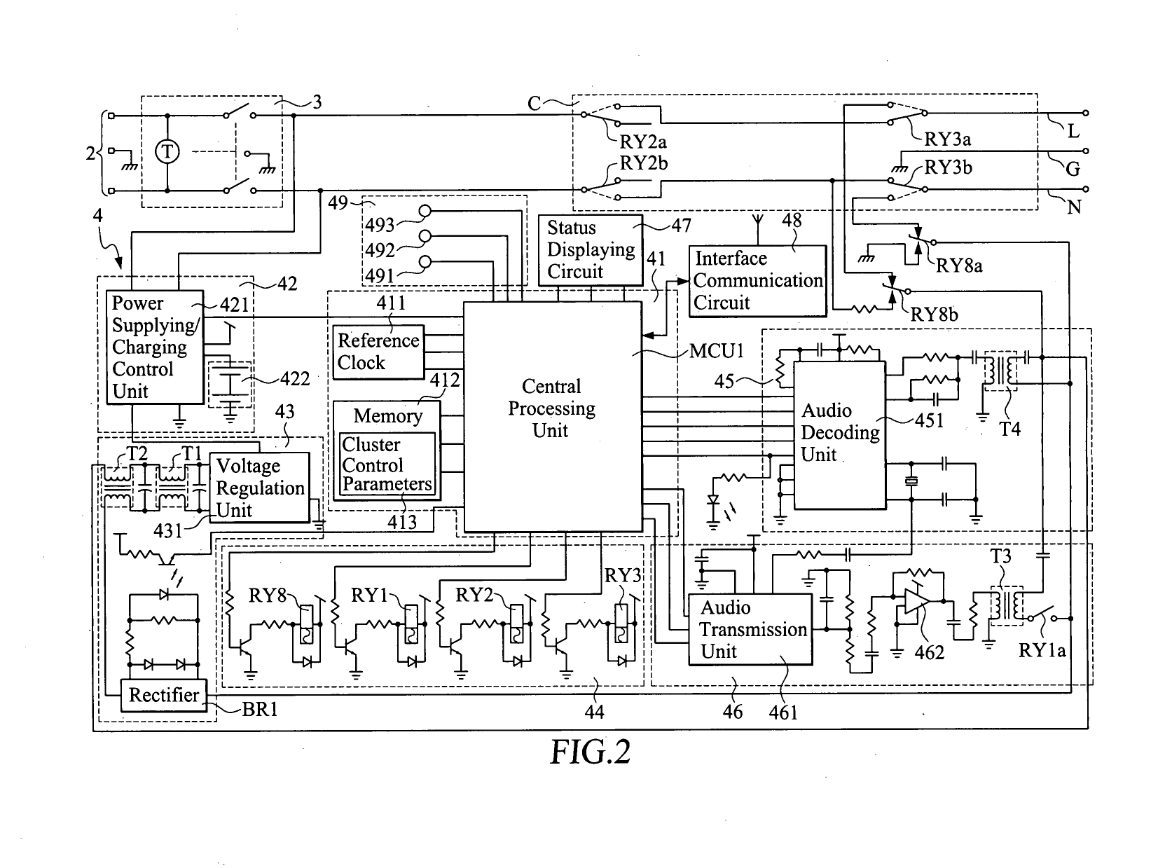

Referring to FIG. 2, the master controller 4 comprises a central control circuit 41, which is electrically connected to a power supplying/charging control circuit 42, a communication power-feeding circuit 43, a system conversion control circuit 44, an audio decoding circuit 45, an audio transmitter circuit 46, a status displaying circuit 47, an interface communication circuit 48, and an input detection circuit 49.

The central control circuit 41 comprises a central processing unit MCU1, a reference clock 411, and a memory 412. The reference clock 411 generates a reference time. The memory 412 stores cluster control parameters 413. The cluster control parameters 413 store data including year-round sunrise/sunset time table, system malfunction records, initial system voltage/current, number of controlled control modules, brightness period and brightness ratio, reporting phone number, phone number for dialing connection for master control.

The power supplying/charging control circuit 42 comprises a power supplying/charging control unit 421 and a battery set 422 and stores the electrical power supplied from the power supply circuit C1 in the battery set 422 to provide electrical power to the master controller 4 and to provide the current status of power supplying to the central processing unit MCU1.

The communication power-feeding circuit 43 comprises a voltage regulation unit 431, a rectifier BR1, and couplers T1, T2 and functions to supply electrical power to the control modules 5a, 5b, 5c at the time when the master controller 4 are in communication with the control modules 5a, 5b, 5c and also to detect if communication is being performed or the line is busy for communication.

The system conversion control circuit 44 comprises four relays RY1, RY2, RY3, RY8, which are used to control switching between operations of the power supply circuit C1 in accordance with the cluster control parameters 413 stored in the memory 412.

The audio decoding circuit 45 comprises an audio decoding unit 451, which applies an audio code transmitted from the control modules 5a, 5b, 5c, after being properly decoded by being coupled by a coupler T4, to the central processing unit MCU1 for subsequent processing. The audio transmitter circuit 46 comprises an audio transmission unit 461 and an amplifier 462, whereby when the central processing unit MCU1 drives the relay RY1 to have a relay contact RY1a closed, an audio code is transmitted through a coupler T3 to be received by the control modules 5a, 5b, 5c.

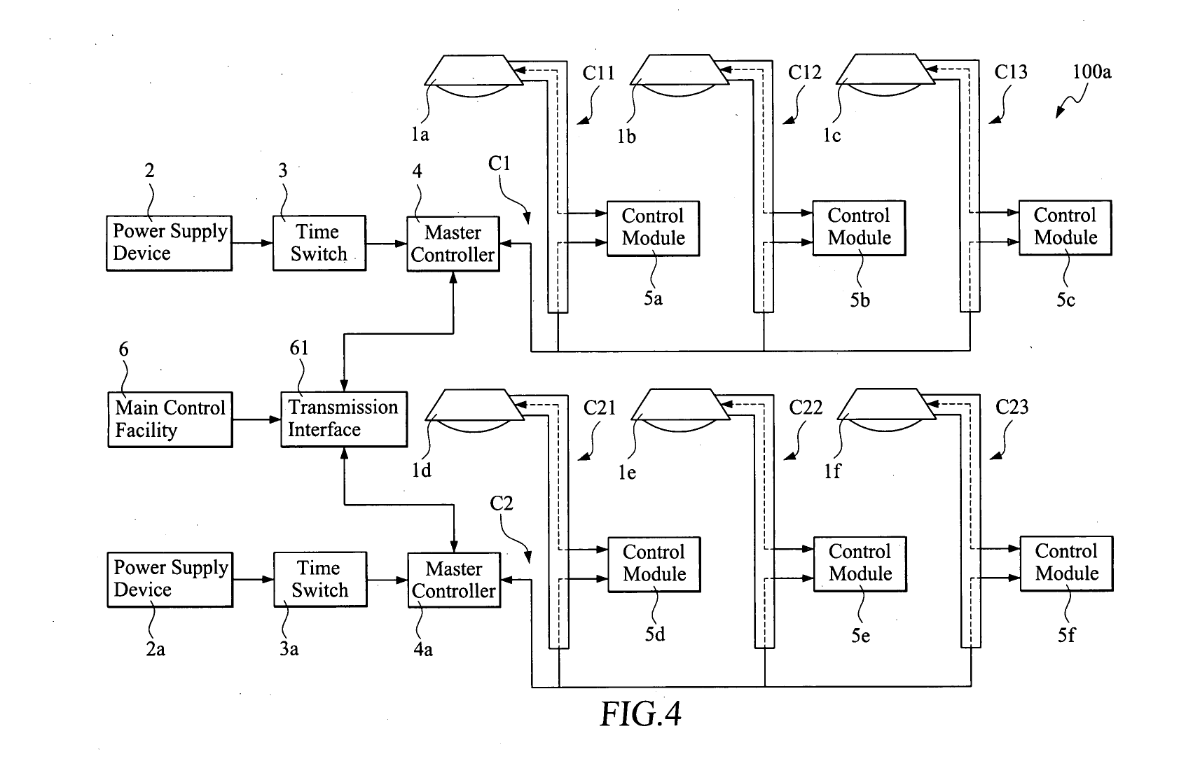

The status displaying circuit 47 is controlled by an output from the central processing unit MCU1 to display all sorts of status and control modes of the master controller 4. The interface communication circuit 48 allows the master controller 4 to carry out data transmission with a main control facility 6 (see FIG. 4) through the interface communication circuit 48. The interface communication circuit 48 can be for example wireless GPRS communication circuit or wired RS485 communication circuit, the use of these communication circuits being dependent upon requirement of applications.

The input detection circuit 49 functions to retrieve external input signals to be processed by the central processing unit MCU1. In the instant embodiment, the external input signals are from a light detection element 491 and a hand-hole cover 492. If desired, depending upon the applications used, the external input signals can be supplied by other sensors 493.

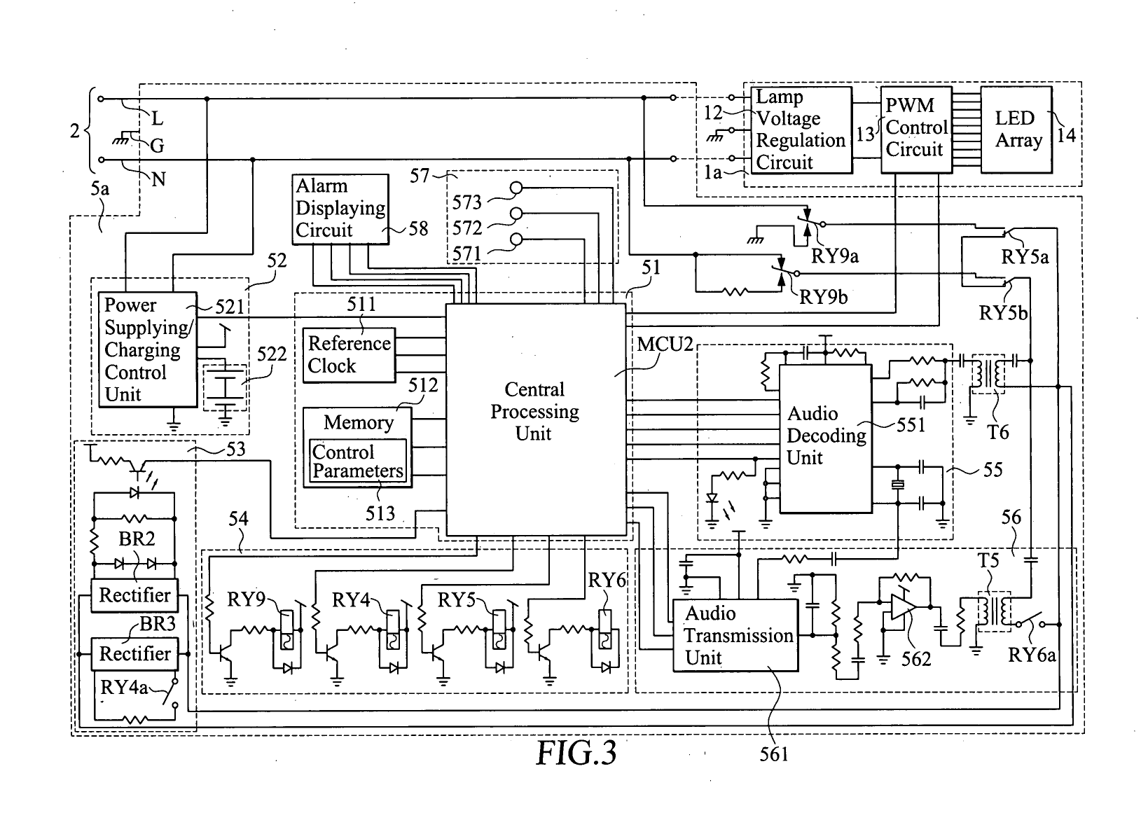

Referring to FIG. 3, the control module 5a comprises a central control circuit 51, which is connected to a power supplying/charging control circuit 52, a line detection control circuit 53, a system conversion control circuit 54, an audio decoding circuit 55, an audio transmitter circuit 56, an input detection circuit 57, and an alarm displaying circuit 58.

The central control circuit 51 comprises a central processing unit MCU2, a reference clock 511, and a memory 512. The reference clock 511 generates a reference time, and can perform periodic remote synchronization calibration through the master controller 4. The memory 512 stores control parameters 513. The control parameters 513 store data including year-round sunrise/sunset time table, lamp type, lamp malfunction records, serial number of control module, brightness period and brightness ratio, and reporting phone number.

The power supplying/charging control circuit 52 comprises a power supplying/charging control unit 521 and a battery set 522 and stores the electrical power supplied from the power supply circuit C1 in the battery set 522 to provide electrical power to the control module 5a and also to provide the current status of power supplying to the central processing unit MCU2.

The line detection control circuit 53 comprises rectifiers BR2, BR3 for detecting if the power supply circuit C1 is in a busy condition. The system conversion control circuit 54 comprises four relays RY4, RY5, RY6, RY9, which are used to control switching operation of the power supply circuit C1 in accordance with the control parameters 513 stored in the memory 512.

The audio decoding circuit 55 comprises an audio decoding unit 551, which applies an audio code transmitted from the master controller 4 or other control modules 5b, 5c, after being properly decoded by being coupled by a coupler T6, to the central processing unit MCU2 for subsequent processing. The audio transmitter circuit 56 comprises an audio transmission unit 561 and an amplifier 562, whereby when the central processing unit MCU2 drives the relay RY4 to have a relay control RY4a occupying the line and also drives the relay RY6 to have a relay contact RY6a closed, an audio code is transmitted through a coupler T5 to be applied to the power supply circuit C1 for being received by the master controller 4 or the other control modules 5b, 5c.

The input detection circuit 57 functions to retrieve external input signals to be processed by the central processing unit MCU2. In the instant embodiment, the external input signals are from a light detection element 571 and a hand-hole cover 572. If desired, depending upon the applications used, the external input signals can be supplied by other sensors 573. The alarm displaying circuit 58 is driven by the central processing unit MCU2 for displaying the operation condition of the control module 5a and alarms and for issuing different types of intermittent alarming signals.

Referring to FIGS. 1 to 3, in the instant embodiment, the street lamp 1a comprises a light-emitting diode (LED) lamp, which is composed of a lamp voltage regulation circuit 12, a pulse width modulation (PWM) control circuit 13 connected to the lamp voltage regulation circuit 12, and an LED array 14. It is noted that the street lamp 1a can alternatively comprise a semiconductor lamp, a sodium vapor lamp, or an electrodeless lamp. When the cluster control device 100 is set in a lighting mode, the electrical power supplied from the power supply device 2 is transmitted through the time switch 3 and the power supply circuit C1 to the street lamp 1a. The PWM control circuit 13 is controlled by the control module 5 to adjust the illuminance provided by the LED array 14 of the street lamp 1a.

The power supply circuit C1 comprises a phase line L, a neutral line N, and a ground line G. When the cluster control device 100 is set in a communication mode, the master controller 4 drives the relay RY2 to open relay contacts RY2a, RY2b so as to make open circuiting between the phase line L and the neutral line N and the time switch 3 and also drives the relay RY3 to close relay contacts RY3a, RY3b so as to make closed circuiting between the phase line L and the neutral line N and the master controller 4; and the control module 5a drives the relay RY5 to switch relay contacts RY5a, RY5b so as to make closed circuiting between the control module 5a and the phase line L and the neutral line N to thereby constitute a first communication transmission path, whereby the master controller 4 is in communication with the control module 5a, 5b, 5c through the power supply circuit C1 and the master controller 4 is allowed to read/write data of the control parameters 513 stored in the memory 512 of the control module 5a according to the cluster control parameters 413.

Further, the master controller 4 also drives the relay RY8 to switch relay contacts RY8a, RY8b to selectively use the phase line L or the neutral line N, and the ground line G; and the control module 5a drives the relay RY9 to switch relay contacts RY9a, RY9b in order to selectively use the phase line L or the neutral line N, and the ground line G to thereby constitute a second communication transmission path.

Although in the instant embodiment, the master controller 4 uses the power supply circuit C1 to establish communication with each control module 5a, 5b, 5c, the communication of the master controller 4 with the control modules 5a, 5b, 5c can be alternatively established in a wireless manner and for reading/writing the control parameters 413 stored in the memory 412 of the master controller 4.

FIG. 4 shows a second embodiment of a cluster control device constructed in accordance with the present invention, generally designated at 100a for distinction, which possess a structure that is similar to the cluster control device 100 of the first embodiment discussed previously, so that similar components are designated with the same reference numerals for correspondence and simplicity.

In the second embodiment, the cluster control device 100a further comprises a power supply circuit C2 that is electrically connected to a plurality of street lamp circuits C21, C22, C23, each comprising a street lamp 1d, 1e, 1f. The power supply circuit C2 transmits electrical power supplied from a power supply device 2a, through a time switch 3a, to each of the street lamps 1d, 1e, 1f. Each street lamp 1d, 1e, if is connected to a control module 5d, 5e, 5f, which is selectively set in communication a the master controller 4a.

The second embodiment offers a feature that the master controllers 4, 4a use the respective interface communication circuit 48 (see FIG. 2) to connect to the main control facility 6 through a transmission interface 61, thereby forming a nest-architecture system. In this way, the main control facility 6 is allowed to carry out clustered control of all the control modules 5a, 5b, 5c, 5d, 5e, 5f through the master controllers 4, 4a.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A cluster control device adapted to control a plurality of street lamps connected to at least one power supply circuit, the power supply circuit transmitting electrical power supplied from a power supply device to the street lamps, the cluster control device comprising:
a plurality of control modules, which is respectively connected to the street lamps, each control module comprising a memory storing at least one control parameter to allow the control module to control the respective street lamp according to the control parameter; and
at least one master controller, which is communicateable with each of the control modules to access the control parameter stored in the memory of the control module.

2. The cluster control device as claimed in claim 1, wherein the master controller comprises a system conversion control circuit to selectively establish closed circuiting between the power supply device and the power supply circuit whereby the electrical power supplied from the power supply device is allowed to transmit through the power supply circuit to the street lamps and to selectively form a communication path between the master controller and the power supply circuit for communication between the master controller and the control modules.

3. The cluster control device as claimed in claim 1, wherein the master controller comprises an audio transmitter circuit, by which the master controller communicates with the control modules.

4. The cluster control device as claimed in claim 1, wherein the master controller comprises an interface communication circuit, through which the master controller is adapted to carry out data exchange with main control facility.

5. The cluster control device as claimed in claim 4, wherein the interface communication circuit selectively comprises a GPRS communication circuit or an RS485 communication circuit.

6. The cluster control device as claimed in claim 1, wherein the master controller comprises a memory, which stores a cluster control parameter, whereby the master controller accesses the control parameters stored in the memories of the control modules according to the cluster control parameter.

7. The cluster control device as claimed in claim 1, wherein each of the control modules comprises a system conversion control circuit to selectively establish closed circuiting between the power supply device and the respective street lamp whereby the electrical power is allowed to transmit through the power supply circuit to the street lamp and to selectively form a communication path between the controller module and the power supply circuit for communication between the control module and the master controller.

8. The cluster control device as claimed in claim 1, wherein the street lamp selectively comprises a semiconductor lamp, a light-emitting diode lamp, a sodium vapor lamp, or an electrodeless lamp.

9. A cluster control device for street lamp circuits, comprising:
a power supply circuit, which transmits electrical power supplied from a power supply device;
a plurality of street lamp circuits, which are electrically connected to the power supply circuit, each of the street lamp circuits comprising at least one street lamp and a control module connected to the street lamp, the control module comprising a memory storing at least one control parameter to allow the control module to control the street lamp according to the control parameter; and
at least one master controller, which is communicateable with each of the control modules to access the control parameter stored in the memory of the control module.

10. The cluster control device as claimed in claim 9, wherein the master controller comprises a system conversion control circuit to selectively establish closed circuiting between the power supply device and the power supply circuit whereby the electrical power supplied from the power supply device is allowed to transmit through the power supply circuit to the street lamps and to selectively form a communication path between the master controller and the power supply circuit for communication between the master controller and the control modules.

11. The cluster control device as claimed in claim 9, wherein the master controller comprises an audio transmitter circuit, by which the master controller communicates with the control modules.

12. The cluster control device as claimed in claim 9, wherein the master controller comprises an interface communication circuit, through which the master controller is adapted to carry out data exchange with main control facility.

13. The cluster control device as claimed in claim 12, wherein the interface communication circuit selectively comprises a GPRS communication circuit or an RS485 communication circuit.

14. The cluster control device as claimed in claim 9, wherein the master controller comprises a memory, which stores a cluster control parameter, whereby the master controller accesses the control parameters stored in the memories of the control modules according to the cluster control parameter.

15. The cluster control device as claimed in claim 9, wherein each of the control modules comprises a system conversion control circuit to selectively establish closed circuiting between the power supply device and the street lamp connected to the control module, whereby the electrical power is allowed to transmit through the power supply circuit to the street lamp and to selectively form a communication path between the controller module and the power supply circuit for communication between the control module and the master controller.

16. The cluster control device as claimed in claim 9, wherein the street lamp selectively comprises a semiconductor lamp, a light-emitting diode lamp, a sodium vapor lamp, or an electrodeless lamp.
